(19) United States
(12) Patent Application Publication
(10) Pub. No.: US 2019/0377207 A1
(43) Pub. Date: Dec. 12, 2019

(54) PATTERNED LIGHT-ADJUSTING GLASS AND PREPARATION METHOD THEREOF

(71) Applicants: SOUTH CHINA NORMAL UNIVERSITY, Guangzhou,Guangdong (CN); SHENZHEN GUOHUA OPTOELECTRONICS CO., LTD,, Shenzhen, Guangdong (CN); ACADEMY OF SHENZHEN GUOHUA OPTOELECTRONICS, Shenzhen, Guangdong (CN)

(72) Inventors: Guofu ZHOU, Shenzhen, Guangdong (CN); Xiaowen HU, Guangzhou, Guangdong (CN); Nan LI, Shenzhen, Guangdong (CN)

(21) Appl. No.: 16/476,659

(22) PCT Filed: Nov. 8, 2017
(86) PCT No.: PCT/CN2017/109810

§ 371 Date: Jul. 9, 2019

(30) Foreign Application Priority Data
Jan. 9, 2017 (CN) 201710014371.9

(51) Int. Cl. G02F 1/13; G02F 1/1334; G02F 1/1343

(52) U.S. Cl. CPC G02F 1/1313; G02F 1/1334; G02F 2001/134318; G02F 1/13439; G02F 1/134309

(57) ABSTRACT

A patterned light-dimming glass and a preparation method therefor. The light-dimming glass comprises two oppositely disposed transmitting conductive substrates that are packaged to form a regulating area (6); each of the two transmitting conductive substrates comprises a substrate (1) and an electrode layer (2) installed on a surface opposite to the substrate (1); and at least one of the two electrode layers (2) is an electrode layer (2) having a pattern. When voltage is not applied to the transmitting conductive substrates, the light-dimming glass is transparent, and the pattern of the electrode layer (2) is displayed. The method for preparing the electrode layer (2) having a pattern comprises the steps of: preparing a whole electrode layer (2′) on the substrate (1); coating a photoetching glue layer (3′) on the whole electrode layer (2′); preparing a photoetching plate (4) which has a pattern, and covering the the photoetching plate (4) over photoetching glue layer (3′); exposing; developing; postbaking; and corroding the electrode layer (2′) which is not covered by the photoetching glue layer (3′), thus obtaining the electrode layer (2) having a pattern. By using said method to prepare the electrode layer (2), a pattern having an accuracy which achieves micron level may be prepared.

### FIELD

The present disclosure relates to the fields of articles for building, household and living, and more particularly, to a patterned light-adjusting glass and a preparation method thereof.

### BACKGROUND

Most light-adjusting glass can be formed by a process of coating a film on the surface, for which the used films are made of different materials to enable light with a certain wavelength in a ray of light to be reflected or transmitted by a glass window according to different requirements on light reflection and transmission, so as to realize sunlight transmission and reflection. For example, on the surface of the glass for some vehicle windows there is a coating layer which has a high blocking effect on visible light resulting in a better hiding effect inside the vehicle. However, the coated glass greatly affects a visual performance of people in the vehicle to watch outside. Once a structure of the coated glass is formed, the optical performance thereof cannot reversibly adjust brightness according to environmental changes or personal preferences, which is difficult to meet the needs for people to change brightness inside the vehicle at any time. Similarly, in the case that the coated glass used in the existing window can reflect light with a certain wavelength in visible light after molding, once the coated glass is formed, brightness adjustment cannot be realized. In addition, most reflective materials used in the coated glass are based on an ionic crystal doped with metal and metal oxide, however the reflective materials forming the glass may easily interfere navigation and communication systems. Due to this shortcoming, the coated glass is difficult to be used in building, house and living, and is also difficult to be popularized and widely applied in the world.

In view of limitations of the coated glass, light-adjusting glass based on a new light-adjusting technology has been emerged. At present, there have been some research results. To some extent, the light-adjusting glass can play a role of a curtain and eliminate the limitations of the coated glass, and therefore it has a good application prospect in vehicle window glass, home glass and so on. Regarding a light-adjusting glass based on electrical response, a turning direction of liquid crystal is changed by powering on and off, so that the transmission, scattering or reflection of light are adjusted. However, at present, the light-adjusting glass based on electrical response only has two forms of transparency and obscuring. At present, there is no light-adjusting glass displaying patterns. In some application for customer demand, the glass need to display a certain pattern in a transmission state according to personalized requirement. Therefore it is necessary to provide a patterned light-adjusting glass in order to meet the requirement of customer.

### SUMMARY

The technical problem to be solved by the present disclosure is to provide a patterned light-adjusting glass and a preparation method thereof.

The technical solutions used in the present disclosure are as follows.

A light-adjusting glass comprises two oppositely disposed light-transmitting conductive plates that are packaged to form an adjusting area, wherein each of the two light-transmitting conductive plates includes a substrate and an electrode layer disposed on a surface opposite to the substrate. The adjusting area is filled with a liquid crystal mixture. At least one of the two electrode layers is an electrode layer having a pattern. The liquid crystal mixture contains negative liquid crystals, so that if a voltage is not applied between the light-transmitting conductive plates, the negative liquid crystals are arranged in a single domain perpendicular to the light-transmitting conductive plates, and if the voltage is applied between the light-transmitting conductive plates, the negative liquid crystals are arranged in a multi-domain parallel to the light-transmitting conductive plates.

In some preferred embodiments, the electrode layer is an ITO electrode.

In some preferred embodiments, the two electrode layers are both electrode layers having patterns, and the patterns of the two electrode layers are different.

In some preferred embodiments, the liquid crystal mixture includes negative liquid crystals, a photopolymerizable liquid crystal monomer and a photoinitiator; under the effects of ultraviolet light and the photoinitiator, the liquid crystal monomer is polymerized to form a polymer network, and the negative liquid crystals are dispersed in the polymer network.

In a preferred embodiment of the solutions above, opposite surfaces of the two light-transmitting conductive plates are coated with vertical alignment layers.

In a further preferred embodiment of the solutions above, the liquid crystal mixture further includes a dichroic dye molecule, and the dichroic dye molecule is dispersed in the polymer network.

In a further preferred embodiment of the solutions above, a size of the dichroic dye molecule in a direction parallel to the light-transmitting conductive plates is not equal to that in a direction perpendicular to the light-transmitting conductive plates.

In some preferred embodiments, the light-adjusting glass also includes a power supply component, and conducting layers of two light-transmitting conductive plates are respectively electrically connected with two poles of the power supply component.

The present disclosure further provides a preparation method of the light-adjusting glass above, which includes a step of preparing the electrode layer having a pattern, and specifically includes:

preparing a whole electrode layer on the substrate;

coating a photoresist layer on the whole electrode layer;

preparing a photoetching plate having a pattern, and covering the photoetching plate on the photoresist layer;

exposing;

developing;

post-baking;

and corroding the electrode layer which is not covered by the photoresist layer, thus obtaining the electrode layer having a pattern.

In some preferred embodiments, the thickness of the photoresist layer coated on the electrode layer is uniform.

In some preferred embodiments, if the photoresist layer is a positive photoresist layer, a pattern of a light-proof part of the photoetching plate is the pattern of the electrode layer; and if the photoresist layer is a negative photoresist layer, a pattern of a light-transmitting part of the photoetching plate is the pattern of the electrode layer.

The present disclosure has the beneficial effects as follows.

The traditional light-adjusting glass is transparent in a transmission state, cannot display any pattern, and cannot meet personalized requirements of some customers. The patterned light-adjusting glass according to the present disclosure includes two oppositely disposed light-transmitting conductive plates that are packaged to form the adjusting area. Each of the two light-transmitting conductive plates includes the substrate and the electrode layer disposed on the surface opposite to the substrate. At least one of the two electrode layers is the electrode layer having a pattern, the adjusting area is filled with the liquid crystal mixture containing the negative liquid crystal. If the voltage is not applied between the light-transmitting conductive plates, the negative liquid crystals are arranged in the single domain perpendicular to the light-transmitting conductive plates, at the moment, visible light is transmitted from the liquid crystal mixture, and the glass shows the pattern of electrode layer. If the voltage is applied between the light-transmitting conductive plates, the negative liquid crystals are turned to a direction perpendicular to the electric field under the electric field, that is, the negative liquid crystals are turned to a direction parallel to the light-transmitting conductive plates. Under a blocking effect of other substances in the liquid crystal mixture, the negative liquid crystals are arranged in the multi-domain parallel to the light-transmitting conductive plates, thus enhancing light scattering, so that the light-adjusting glass is transformed from the light-transmitting state to the light-scattering state, and the light-adjusting glass is transformed into an obscure state. The preparation method of the electrode layer having a pattern includes: preparing a whole electrode layer on the substrate, coating the photoresist layer on the electrode layer, preparing a photoetching plate having a pattern, covering the photoetching plate on the photoresist layer, exposing, developing, post-baking, and corroding the electrode layer which is not covered by the photoresist layer, thus obtaining the electrode layer having a pattern. By using the method to prepare the electrode layer, a pattern having an accuracy achieving a micron level can be prepared.

### BRIEF DESCRIPTION OF THE DRAWINGS

FIG. 1 is a schematic diagram illustrating a preparation process of an electrode layer having a pattern.

FIG. 2 is a top view of a light-adjusting glass.

FIG. 3 is a sectional view of the light-adjusting glass without a voltage applying.

FIG. 4 is a sectional view of the light-adjusting glass with a voltage applying.

FIG. 5 is a top view of the light-adjusting glass with a voltage applying.

### DETAILED DESCRIPTION

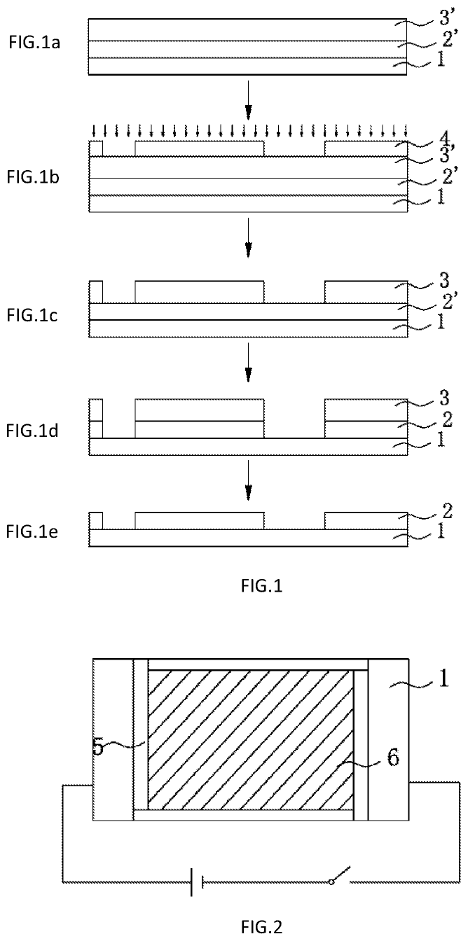

Referring to FIG. 1, it is a schematic diagram illustrating a preparation process of an electrode layer having a pattern. As shown in FIG. 1a, firstly a substrate 1 made of glass material is cut and prepared; then a complete conducting layer 2′ is prepared on the substrate 1; and a photoresist layer 3′ is coated on the complete conducting layer 2′. The conducting layer 2′ can be an ITO electrode film. The photoresist can be a positive photoresist or a negative photoresist. The uniformity of the thickness of the photoresist layer 3′ can affect a photoetching quality, so that the thickness uniformity of the photoresist layer 3′ is ensured, and the photoetching quality can be ensured. Further, the thickness of the photoresist layer 3′ is controlled to be 1 μm to 3 μm. The coating process can be any possible process, such as dip coating process, spin coating process, etc. In the shown embodiment, the spin coating process is used, in which the substrate 1 is placed on a platform rotating in a high speed, the photoresist layer 3′ with a uniform thickness is formed on a surface of the conducting layer 2′ by a centrifugal force and a surface tension of a photoresist liquid, and the thickness of the photoresist layer 3′ can be adjusted according to a rotating speed and a spinning time. Subsequently, as shown in FIG. 1b, a photoetching plate 4 having a pattern is prepared, and the photoetching plate 4 is covered on the photoresist layer 3′. The substrate 1 coated with the photoresist layer 3′ covered by the photoetching plate 4 is irradiated by ultraviolet light for exposure. In the embodiment, the positive photoresist irradiated by the ultraviolet light occurs a reaction. In order to ensure the exposure quality of the reaction, the exposure time must be strictly controlled. If the exposure time is too short, the photoresist is insufficiently exposed, which affects corrosion; and if the exposure time is too long, a part that shall not be exposed is exposed, which directly affects a subsequent process. The exposure time is preferably 12 s to 15 s, and most preferably 13 s. After the photoetching plate 4 is removed, and the photoresist exposed is removed by a developing solution, so that the photoresist layer 3′ obtained has the same pattern as a light-proof part of the photoetching plate 4. A development time shall be strictly controlled. If the development time is insufficient, the photoresist remains on the surface, which affects a corrosion effect; and if the development time is too long, the photoresist near the surface is excessively dissolved by the developing solution, resulting in a step influence. In a test, the development time is set as 2 min at a room temperature. After the development is completed, the substrate 1 developed needs to be placed on a hot plate at 100° C. and baked for 30 s. The purpose of post-baking is to improve an ability of the photoresist to protect the lower surface during corrosion. In addition, an adhesion between the photoresist and the ITO electrode layer can further be enhanced, but a post-baking time cannot be too long, otherwise the photoresist will flow. A structure after development and post-baking is shown in FIG. 1c. Subsequently, with reference to FIG. 1d, the ITO electrode film that is not covered by the photoresist layer 3 is corroded to obtain the conducting layer 2 having a pattern. The pattern of the conducting layer 2 is the same as that of the photoresist layer 3 and is the same as that of the light-proof part of the photoetching plate 4. A corrosion process can be a dry corrosion process or a wet corrosion process. In the embodiment, the wet corrosion process is used, in which concentrated hydrochloric acid with a concentration of 36.8% is used to corrode the ITO electrode film. The corrosion effect is controlled by accurately adjusting a corrosion time. If the corrosion time is too long, the ITO film protected by the photoresist can also be corroded; and if the corrosion time is too short, the ITO electrode film cannot be completely corroded. The corrosion effect is determined by testing a resistance value of ITO glass in the process engineering. If the corrosion time is 70 s, the ITO film is found to be completely corroded according to the test, that is, the resistance thereof is deem as infinite. Finally, with reference to FIG. 1e, the photoresist layer 3 covered on the electrode layer 2 is removed to form a light-transmitting conductive plate retaining the conducting layer 2 having a pattern on the substrate 1., The pattern of the conducting layer 2 is the same as that of the light-proof part of the photoetching plate 4. If a negative photoresist is used, the obtained photoresist layer 3 has the same pattern as a light-transmitting part of the photoetching plate 4, and the obtained conducting layer 2 also has the same pattern as the light-transmitting part of the photoetching plate 4.

The upper and lower light-transmitting conductive plates are prepared according to the method above. The patterns of the conducting layers 2 of the two light-transmitting conductive plates can be the same or different. Next, according to a traditional preparation method of light-adjusting glass, a vertical alignment layer is coated and prepared on the conducting layer 2, and then a packaging frame is formed by means of a UV curing adhesive and a spacer so as to obtain a liquid crystal box. Under a yellow light condition, negative liquid crystals, a photopolymerizable liquid crystal monomer, a photoinitiator and a dichroic dye are added into a brown reagent bottle according to a ratio of 96.38:3:0.5:0.12, and then are evenly mixed to obtain a liquid crystal mixture. Under yellow light, the liquid crystal mixture is heated to 60° C. to convert the liquid crystal into an isotropic liquid state, then the liquid crystal mixture is injected into the liquid crystal box at the temperature. After filling the box, a liquid crystal molecule is aligned by keeping the temperature for 30 min; and the filled liquid crystal box is cured under 200 W ultraviolet light for 5 min to bond the liquid crystal monomers to form a liquid crystal mixture network, thus preparing the light-adjusting glass.

The top view of the light-adjusting glass is shown in FIG. 2. The light-adjusting glass includes two oppositely arranged light-transmitting conductive plates and a power supply component including a DC power supply. A voltage adjusting device is integrated on the DC power supply to directly adjust a power supply voltage. The two light-transmitting conductive plates are respectively electrically connected with two poles of the power supply component. Each of the two light-transmitting conductive plates includes the substrate 1 and the electrode layer 2 arranged on the surface of the substrate 1. Two electrode layers 2 are respectively electrically connected with the two poles of the power supply component. A packaging glue frame 5 is arranged between the two light-transmitting conductive plates. An adjusting area 6 is packaged between the two light-transmitting conductive plates with the packaging glue frame 5.

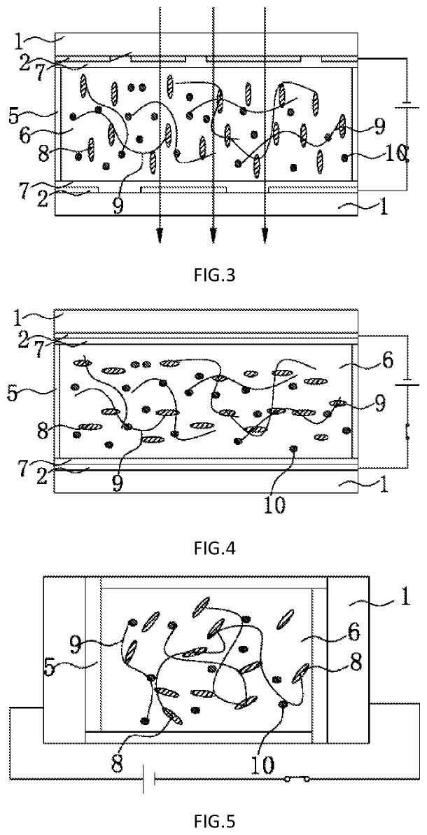

The sectional view of the light-adjusting glass without applying a voltage is shown in FIG. 3. Opposite surfaces of the two conducting layers 2 are coated with the vertical alignment layers 7. The adjusting area 6 is filled with the liquid crystal mixture. The liquid crystal mixture includes the photopolymerizable liquid crystal monomer, the photoinitiator and the negative liquid crystal 8, under effects of the ultraviolet light and the photoinitiator. The liquid crystal monomers are polymerized to form a polymer network 9, in which the negative liquid crystals 8 are dispersed. If the voltage is not applied between the light-transmitting conductive plates, the negative liquid crystal 8 is arranged in a single domain perpendicular to the light-transmitting conductive plates under an effect of the vertical alignment layer 7. Visible light is transmitted from the liquid crystal mixture, therefore the light-adjusting glass is in a transparent state, and the pattern of the conducting layer 2 is displayed.

Referring to FIG. 4 and FIG. 5, FIG. 4 is a sectional view of the light-adjusting glass with a voltage applying, and FIG. 5 is a top view of the light-adjusting glass with a voltage applying. The dielectric constant for a molecular long axis direction of the negative liquid crystal 8 is smaller than the dielectric constant for a molecular short axis direction, therefore the molecular of the negative liquid crystals are arranged perpendicular to an electric field direction in the electric field. If the voltage is applied between the light-transmitting conductive plates, the negative liquid crystal 8 can be turned to a direction perpendicular to the electric field. Due to irregular distribution of the polymer network 9, the negative liquid crystal 8 is turned to be in in a multi-domain arrangement parallel to the light-transmitting conductive plates, so that light scattering is enhanced, the light-adjusting glass is transformed from a light transmission state to a light scattering state, and the light-adjusting glass is in a not-transparent state, i.e., an obscure state. If the voltage applied to the light-transmitting conductive plates is removed, the negative liquid crystal 8 is driven to be restored to an initial state perpendicular to the light-transmitting conductive plates by a common restoring effect of the polymer network 9 and the vertical alignment layer 7; in the present disclosure, the response time is short, which is about 100 ms to 200 ms. The traditional light-adjusting glass relies on an effect of the vertical alignment layer to make the liquid crystal molecules rotate and restore to the initial state perpendicular to the light-transmitting conductive plates, and the response time is usually longer than 1 s. The response time of the reverse light-adjusting glass according to the present disclosure is at least 8 times faster than that of the traditional light-adjusting glass.

The liquid crystal mixture further includes dichroic dye molecules 10 that are dispersed in the polymer network 9. The size of the dichroic dye molecule 10 in a direction parallel to the light-transmitting substrates is not equal to that in a direction perpendicular to the light-transmitting substrates, with the voltage applying, the dichroic dye molecule 10 rotates with the negative liquid crystal 8 in a direction parallel to the light-transmitting conductive plates, and the light-adjusting glass is transformed from a transparent state to a color non-transparent state, as the voltage is removed. The dichroic dye molecule 10 can be restored to a state if the voltage is not applied under the effect of the polymer network 9. The dichroic dye molecule 10 does not need to be a long molecule, but only needs to have different sizes in the direction parallel to the light-transmitting substrates and in the direction perpendicular to the light-transmitting conductive plates, so that the state can be restored under the drive of the polymer network 9. Ordinary dye molecule is used in the light-adjusting glass. The light transmittance is greatly reduced if the electricity is not applied, so that the glass shows a very thick color, which affects a use effect and beauty of the light-adjusting glass. But the dichroic dye has different extinction coefficients for parallel polarized light and vertical polarized light, so that the light transmittance is still very high if the electricity is not applied, and the color of the light-adjusting glass can be changed after the electricity is applied.

1. A light-adjusting glass, comprising
two oppositely disposed light-transmitting conductive plates, each of the plates comprising a substrate and an electrode layer disposed on a surface opposite to the substrate, and
an adjusting area packaged between the light-transmitting conductive plates, wherein,
at least one of the two electrode layers has a pattern, and
the adjusting area is filled with a liquid crystal mixture having negative liquid crystals, so that:
if a voltage is not applied between the light-transmitting conductive plates, the negative liquid crystals are arranged in a single domain perpendicular to the light-transmitting conductive plates; and if the voltage is applied between the light-transmitting conductive plates, the negative liquid crystals are arranged in a multi-domain parallel to the light-transmitting conductive plates.

2. The light-adjusting glass according to claim 1, wherein the electrode layer is an ITO electrode.

3. The light-adjusting glass according to claim 1, wherein the two electrode layers both have patterns, and the patterns of the two electrode layers are different.

4. The light-adjusting glass according to claim 1, wherein the liquid crystal mixture comprises negative liquid crystals, a photopolymerizable liquid crystal monomer and a photoinitiator; under the effects of ultraviolet light and the photoinitiator, the liquid crystal monomer is polymerized to form a polymer network; and the negative liquid crystals are dispersed in the polymer network.

5. The light-adjusting glass according to claim 4, wherein opposite surfaces of the two light-transmitting conductive plates are coated with vertical alignment layers.

6. The light-adjusting glass according to claim 4, wherein the liquid crystal mixture further comprises a dichroic dye molecule dispersed in the polymer network.

7. The light-adjusting glass according to claim 6, wherein a size of the dichroic dye molecule in a direction parallel to the light-transmitting conductive plates is not equal to that in a direction perpendicular to the light-transmitting conductive plates.

8. A preparation method for the light-adjusting glass according to claim 1, comprising steps of preparing the electrode layer having a pattern, the steps comprising:
preparing a whole electrode layer on the substrate;
coating a photoresist layer on the whole electrode layer;
preparing a photoetching plate having a pattern, and covering the photoetching plate on the photoresist layer;
exposing;
developing;
post-baking; and
corroding the electrode layer which is not covered by the photoresist layer.

9. The preparation method of the light-adjusting glass according to claim 8, wherein the thickness of the photoresist layer coated on the electrode layer is uniform.

10. The preparation method of the light-adjusting glass according to claim 8, wherein if the photoresist layer is a positive photoresist layer, a pattern of a light-proof part of the photoetching plate is the pattern of the electrode layer; and if the photoresist layer is a negative photoresist layer, a pattern of a light-transmitting part of the photoetching plate is the pattern of the electrode layer.

11. The light-adjusting glass according to claim 2, wherein the two electrode layers both have patterns, and the patterns of the two electrode layers are different.

12. The light-adjusting glass according to claim 5, wherein the liquid crystal mixture further comprises a dichroic dye molecule dispersed in the polymer network.

13. The light-adjusting glass according to claim 12, wherein a size of the dichroic dye molecule in a direction parallel to the light-transmitting conductive plates is not equal to that in a direction perpendicular to the light-transmitting conductive plates.
